(19) United States
(12) Patent Application Publication
(10) Pub. No.: US 2005/0234680 A1
(43) Pub. Date: Oct. 20, 2005

(54) Simplified and optimized process for application user interface testing and validation

(75) Inventors: Richard D. Dettinger, Rochester, MN (US); Daniel P. Kolz, Rochester, MN (US); Frederick A. Kulack, Rochester, MN (US); Shannon E. Wenzel, Colby, WI (US)

Correspondence Address: William J. McGinnis, Jr.;IBM Corporation, Dept. 917, 3605 Highway 52 North, Rochester, MN, 55901-7829, US

(73) Assignee: INTERNATIONAL BUSINESS MACHINES CORPORATION, ARMONK, NY (US)

(21) Appl. No.: 10/824,064

(22) Filed: Apr. 14, 2004

(51) Int. Cl. G06F 15/00

(52) U.S. Cl. 702/182

(57) ABSTRACT

Methods, computers and articles of manufacture for testing and validating user interface content. Documents can be tested for both structure and content. In one embodiment, documents are parsed and compared to determine whether the documents are at least structurally equivalent. Parsed documents may also be compared to determine whether the documents are content the equivalent. In another embodiment, one or more test expressions are executed against one or more of the documents being compared.

### BACKGROUND OF THE INVENTION

1. Field of the Invention

The present invention generally relates to a testing and validation tool for user interface content returned by applications.

2. Description of the Related Art

A significant piece of software quality assurance testing lies in how to address the user interface. Testing and validation is commonly done by comparing the inputs and outputs of one execution of a program against the inputs and outputs of another execution of the program. For example, testing and validation may be accomplished by capturing user actions and resulting screens. The captured information may be stored as control documents. During subsequent executions of the program, the same user actions are repeated and the resulting output is compared to the appropriate control document. If the resulting outputs and the corresponding control documents match, then the application is presumed to be working properly.

Such conventional UI testing and validation approaches are much too inflexible for dynamic applications that undergo constant changes (e.g., enterprise applications). Changing any aspect (e.g., changes to a database, changes to a configuration file for an application, changes to user authorities, etc.) of a computing environment that may be exposed by the application results in a loss from such a testing perspective. This includes changes not only the basic layout of a user interface (i.e., the “skin”), but also to underlying constructs, such as a database accessible by the application. Once such changes have been made, a new capture of inputs and corresponding outputs is needed. Where changes are frequently made, the need to re-capture inputs and corresponding outputs becomes time-consuming and impractical.

Therefore, what is needed is a testing and validation tool and method that accommodates changes to applications.

### SUMMARY OF THE INVENTION

The present invention generally provides for methods, computers and articles of manufacture for testing and validating user interface content.

In a first embodiment, a method of testing content is provided. The method includes parsing, by a parser, two or more documents in tandem on an element-by-element basis, whereby the elements of each of the documents are sequentially parsed. Upon parsing an element in a first document of the two or more documents and a respective element in each of the other documents, the respective parsed elements are compared to one another. On the basis of the comparison, it is determined whether the documents are at least equivalent. In one embodiment, each of the other documents is a current response from an application responding to a submitted request and the first document is a control document retrieved from storage and previously returned from the application in response to the request.

Another embodiment provides a method of testing and validating user interface content in which each element of at least two documents is sequentially determined. For at least some of the corresponding sequentially determined elements from the respective documents, the elements are compared to one another to determine whether the elements are equivalent.

Another embodiment provides a method for testing and validating content in a user interface by performing at least two testing and validation techniques. In a first testing and validation technique at least two documents are parsed by a first parser. The documents are then compared to determine whether the documents are structurally equivalent. In a second testing and validation technique at least one of the two documents is parsed with a second parser. One or more test expressions are then applied to the parsed second document, and a determination is made as to whether the one or more test expressions are satisfied.

Yet another embodiment provides a computer readable medium containing a program which, when executed, performs an operation for testing content. The operation includes parsing a pair of documents each being well-formed and having identifiable structures. The documents are compared to determine whether the documents are at least structurally equivalent.

Still another embodiment provides a computer including a user interface testing tool comprising at least a first parser and a comparator. The testing tool is operable to perform at least a first testing technique in which the tool is configured to retrieve a first document from storage, the first document having been previously returned from an application in response to user input, and request and receive a second document from the application during a current session in which the application is being accessed by the user interface testing tool. The testing tool is further configured to parse the documents (using the first parser) and to compare (using the comparator) the parsed documents to one another. On the basis of the comparison, the tool determines at least whether the documents are at least structurally equivalent.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram of a client-server environment, in which the server is configured with a user interface testing and validation tool.

FIG. 2 is a flowchart illustrating capture, validation and storage of control documents, and subsequent creation of test expressions and setting of control variables.

FIG. 3 is a flowchart illustrating the performance of two testing techniques with respect to a control document and a live document (i.e. current response from an application).

FIG. 4 is a flowchart illustrating element-by-element parsing of two documents and subsequent comparative testing of the parsed elements to determine structural and/or content equivalence of the documents.

FIG. 5 is a flowchart illustrating a simple one-to-one comparison of elements of two documents.

FIG. 6 is a flowchart illustrating comparison of parsed elements where a portion of the elements in one or both of the documents is disregarded.

FIG. 7 is a flowchart illustrating an internationalization mode of comparison between parsed elements of documents.

FIG. 8 a flowchart illustrating a document testing technique in which test expressions are applied against one or more of the documents being tested.

### DETAILED DESCRIPTION OF THE PREFERRED EMBODIMENTS

### Introduction

The present invention generally is directed to a method, system and article of manufacture for testing and validation documents, such as XHTML documents defining user interfaces. Documents are examined for structural attributes and/or content. In one embodiment, control documents are created and subsequently compared to current output returned from an application. In another embodiment, test expressions are created and run against current output returned from an application to validate targeted elements or sections of the current output.

While reference will be made herein to specific languages (in particular, markup languages) for purposes of describing specific embodiments, the invention is not so limited. It is contemplated that the invention can be implemented in any environment where documents conform to “well-formedness”. In the present context, a well-formed document is one that strictly adheres to all the rules of the language. An example of a well-formed document is an XML document. A characteristic of well-formedness in XML documents is that end tags are always used. In contrast, HTML is an example of a markup language that does not generally produce well-formed documents because it is possible to avoid using end tags. However, it is contemplated that a document that does not exhibit well-formedness can be transformed into a document that does exhibit well-formedness by an appropriate transformation algorithm.

In addition to specific languages, reference is also made to other specific technologies such as SAX parsers, DOM parsers, XPATH queries, etc. Such reference to specific technologies is merely illustrative, and not limiting of the invention.

One embodiment of the invention is implemented as a program product for use with a computer system. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The software of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular nomenclature that follows is used merely for convenience, and thus the invention should not be limited to use solely in any specific application identified and/or implied by such nomenclature.

The invention can be implemented in a variety of hardware/software configurations. Furthermore, embodiments of the present invention can apply to any hardware configuration, regardless of whether the computer systems are complicated, multi-user computing apparatus, single-user workstations, or network appliances that do not have non-volatile storage of their own.

In some embodiments, the invention can be implemented in a client-server configuration including at least one client computer and at least one server computer. The client(s) and server(s) may be executing on a common machine or may be deployed in distributed environment in which the client(s) and server(s) communicate via a network. In a particular embodiment, aspects of the invention are implemented in a web-based environment. However, the client-server model and web-based environment are merely representative models/environments in which the present invention may be implemented, and persons skilled in the art will recognize other possibilities.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

### Embodiments

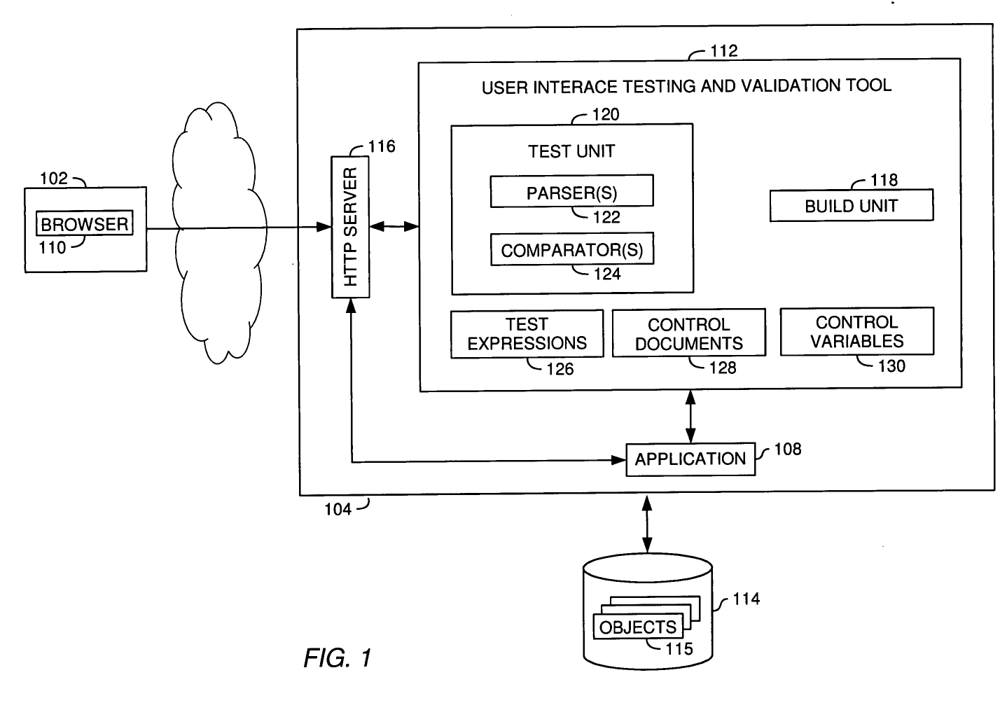

Referring now to FIG. 1, a block diagram of one embodiment of a data processing system 100 is illustrated. Illustratively, the data processing system 100 is a networked environment in which a client computer 102 accesses a server computer 104 via a network 106. In general, the network 106 may be a local area network (LAN) and/or a wide area network (WAN). In a particular embodiment, the network 106 is the Internet and the server computer 104 is a web-based server hosting an application 108 and User Interface Testing and Validation Tool (UI testing tool 112). Accordingly, the client computer 102 is configured with a browser application 110 (browser 110) and the server computer 104 is configured with a Hypertext Transfer Protocol (HTTP) server 116. The browser 1 10 is capable of navigating to the network address of the server computer 104 and submitting user requests to the application 108, via the HTTP server 116. In particular, users may invoke one or more functions implemented by the application 108. In the illustrative embodiment, the application 108 is a database application capable of performing functions with respect to data objects 115 stored in a database 114. However, it is understood that the application 108 may be any application configured to execute user selected functions. It is also understood that the data processing system 100 need not be a web-based environment and that aspects of the invention are described with respect to such an environment for purposes of illustration only. Further, the invention need not be implemented in a networked environment. As such, it is contemplated that the application and the UI testing tool 112 reside locally on a common computer so that the network 106 of FIG. 1 may be considered a local bus.

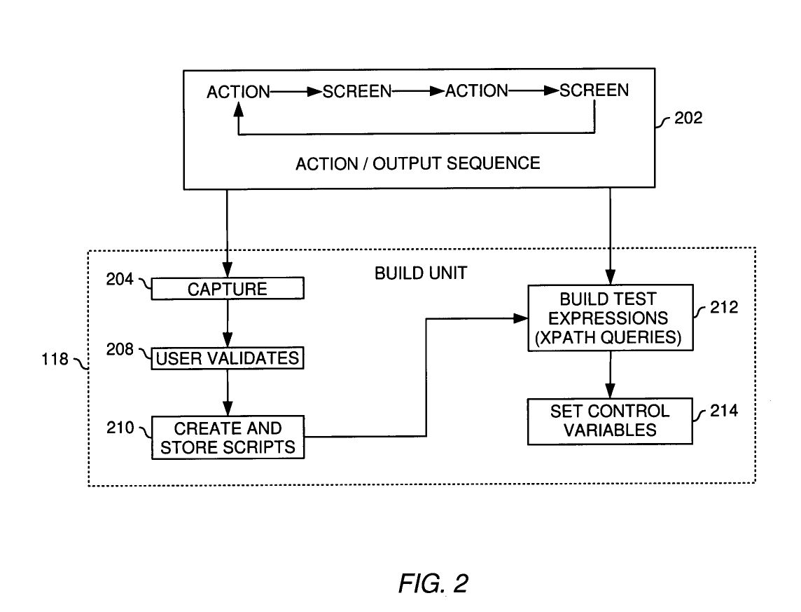

In one embodiment, a user (via the browser 110) submits requests for markup output (e.g., web pages) from the application 108. In response, the application 108 generates markup output and returns the output to the browser 110 for display on a display device of the client computer 102. According to one aspect of the invention, a user's actions (with respect to the application 108) and the corresponding output returned from the application 108 are captured, validated and stored. Specifically, the results returned by the application 108 are stored in the form of control documents 128 and the corresponding actions are stored as scripts 129. On the basis of captured actions/results, a user may then use the UI testing tool 112 to build test expressions 126 and set control variables 130 which are then used by the tool 112 to test and validate documents subsequently output by the application 108 in response to the scripts 129. This functionality of the UI testing tool 112 is implemented by a build unit 118. One embodiment for capturing actions/results (control documents 128 and scripts 129), building test expressions and setting control variables is described below with respect to the SAMPLE ACTION/OUTPUT SEQUENCE, below, and FIG. 2.

FIG. 2 shows a sequence 202 of user actions and corresponding screens, i.e., output returned from the application 108 in response to the user actions. The sequence 202 may be arbitrarily long and, as such, is shown as a recursive pattern. An illustrative sequence is shown below:

SAMPLE ACTION/OUTPUT SEQUENCE

| | |
|---|---|
| Action 1: | Navigate to URL = Home |
| Page 1: | <XHTML . . . > |
| Action 2: | Login User = Y |
| | Password = Y |
| Page 2: | <XHTML . . . > |
| Action 3: | Execute Query |
| Page 3: | <XHTML . . . > |
| . | |
| . | |
| . | |

The SAMPLE ACTION/OUTPUT SEQUENCE above shows an illustrative sequence of user actions and corresponding output (in the form of XHTML) returned from the application 108. Illustratively, a user navigates to a Home page (Action 1→Page 1) and then logins in with the appropriate login ID and password and is presented with, for example, a query input page (Action 2→Page 2). The user then inputs and executes a query against the database 114 and is provided with any query results (Action 3→Page 3).

The build unit 118 operates to capture each action/screen pair by storing a corresponding control document representative of the output returned for a given action (block 204). Assuming proper operation, the user may then validate the captured control document (block 208). In one embodiment, a user then creates and stores corresponding script (block 212) representative of the user actions. In this regard it is noted that the scripts 129 may be independently constructed by a user even in the absence of interacting with an application that outputs results that form the control documents 128. Varying techniques for capturing control documents, validating and creating scripts are known and need not be described in detail. However, even unknown techniques are contemplated for purposes of the present invention.

After the control documents 128 are captured and validated and the scripts are created, the user may build test expressions (block 212) and set control variables (block 214). Referring again to FIG. 1, it is contemplated that, in various embodiments, the test expressions 126 and the control variables 130 may be used in tandem or alternatively. Whether either or both the test expressions 128 and control variables 130 are used depends upon the construction of the test unit 120. For example, in one embodiment, the test unit 120 is configured with one or more parsers 122 and one or more comparators 124. In a specific embodiment, the one or more parsers 122 includes a SAX parser. A SAX (Simple API for XML) parser is an event-based API that reports parsing events (such as the start and end of elements) directly to an application (e.g., the application 108 of the server computer 104) configured to implement an appropriate action. Thus, a SAX parser is referred to as an “event driven” parser. In operation, the SAX parser reads an XML document (e.g., one of the objects 115 in the database 114) sequentially from beginning to end. Each XML tag the parser encounters is regarded as an event. Scanning the XML file from start to end, each event invokes a corresponding callback method. Illustrative events recognized by a SAX parser include encountering the start of a document, encountering the end of a document, encountering the start tag of an element, encountering the end tag of an element, encountering character data, and encountering a processing instruction. A given callback invokes a corresponding event handler designed to perform a specified action. In this way, a plurality of event handlers can be registered with a SAX parser so that when the parser encounters a certain tag, a corresponding event handler (via the appropriate callback method) is invoked. The event handler then processes the data marked by the tag.

Using a SAX parser, pages output by the application 108 may be checked for structural and/or content equivalence. Structural equivalence refers to an identity of corresponding structures between pages, without regard for data contained within the structures. Structures include, for example, tables and frames. Thus, two pages containing the same two tables (Table A and Table B) with the same number of rows and columns are structurally equivalent, even though the data contained within the tables may be different. Content equivalence refers to an identity of content within pages. Examples of content are data and graphical objects, which may themselves be contained within structures. In either case, the checking may be performed by an appropriately configured comparator 124. This approach allows for an event-driven, element-by-element (also referred to herein as “token-by-token”) test between sequentially determined elements of at least two documents. By manipulating callback methods, a user may determine which structures and/or content to compare. As an example, the SAX character data callback may be turned off (e.g., via an appropriate interface of the UI testing tool 112) and a currently accessed page (also referred to herein as the “live document”) is then compared to the corresponding control document (from the control documents 128). This approach may be useful where a captured page (represented by the corresponding control document) includes a table having a plurality of data fields (defined by <td> tags) is subsequently updated to include additional data fields. In one aspect, this embodiment of the present invention can be applied to keep a database (e.g., the database 114) “in sync” from one release to the next. Conventional techniques fail to provide a solution in this situation because any changes to the database 114 can cause pages that are output by the application 108 to change. As such, conventional techniques would require recapturing user actions and corresponding output before testing can be performed. Consider a query executed by the application 108 against the database 114 that returns the following output document:

OUTPUT DOCUMENT FOR A FIRST VERSION OF A DATABASE

```
<html>
  <head>
    <title>simple document</title>
  </head>
  <body>
    <p>My grocery list</p>
    <table>
      <tr>
        <td>beer</td>
        <td>eggs</td>
        <td>cheese</td>
    </table>
  </body>
</html>
```

Now consider that in a subsequent release the database (second version) is augmented with new values (e.g., so that some other test is supported). As a result, the following output document may be returned for the same query that returned the output document for the first version of the database:

OUTPUT DOCUMENT FOR A SECOND VERSION OF A DATABASE

```
<html>
  <head>
    <title>simple document4title>
  </head>
  <body>
    <p>My grocery list</p>
    <table>
      <tr>
        <td>beer</td>
        <td>eggs</td>
        <td>cheese</td>
        <td>more beer</td>
        <td>more eggs</td>
        <td>more cheese</td>
      <tr>
    </table>
  </body>
</html>
```

Thus, the pages remain structurally unchanged, and merely include additional data fields. If an action/result capture is performed with respect to the first page to create a control document, a comparison according to the current state of the art techniques fails because the results changed. In other words, the addition of the data fields “breaks” the previously created script. However, the pages are equivalent from an interface perspective. The only change is to the database which now includes more data. The parsing solution accommodates this change by ignoring the <td> tags as not being significant to the page structure. As a result, if the pages are otherwise unchanged, a comparison between the control document and the live document will result in a match.

The foregoing approach in which character data is ignored is also useful to determine that pages are structurally equivalent even though they are in different languages. For example, a given page may be presented to a user in a language of his or her own choosing, e.g., English, German or Spanish. Regardless of the language, the structure of the pages should be the same. Accordingly, by ignoring character data, the pages can be checked for structural equivalence. Alternatively, it may be desirable to specifically determine that the languages of two or more structurally equivalent pages are different (i.e., to verify proper translation). In this case, the SAX character data callback is turned on and the appropriate comparator 124 checks to ensure that the character data is not the same. That is, a content (non-)equivalence test is performed in which content elements are compared to ensure that they are different from one another. Of course, some languages share the same words (e.g., the word “winter” is the same in English and German). These instances would prompt the user for manual validation. Even so, this approach provides substantial advantages over the labor-intensive approach of the prior art. Accordingly, it is contemplated that, in one embodiment, the UI testing tool 112 is configured with an internationalization mode.

Selectively turning SAX callbacks on and off is merely one contemplated technique for identifying which elements of a page are considered important from a structure or content standpoint. In another embodiment, users (e.g., page developers) may specify particular items considered to be unimportant. For example, consider a document defining a Layout Table and a Results Table. A user may want to specify that the Layout Table is not allowed to vary (i.e., is considered structurally important) and that the Results Table is allowed to vary (i.e., is considered structurally unimportant). Since current SAX callback methods are incapable of distinguishing between tables, enabling or disabling table callback methods is not a workable solution in this instance (without knowledge of the document). Instead, is contemplated that users address this situation via a naming convention of the ID attribute of XHTML tags. For example, ID=“Layout Table” would designate the Layout Table as structurally significant, and ID=“_Results Table” would designate the Results Table as structurally insignificant (because of the presence of the double underscore).

Regardless of the technique used for identifying the relevant structures or content to compare, it is contemplated that the UI testing tool 112 may be configurable allowing a user to enable and disable the available structure/content identification techniques implemented by the UI testing tool 112. For example, a user may desire to disable the structure identification techniques which specify structures to ignore because the user knows that a given database should remain constant. This would be used, for example, when fixing bugs over a short window of time when the user knows that the database would not have changed. Alternately, it could be used to verify that something did change. For example, if the user knows of a join logic problem in a page, configuring the UI testing tool 112 to determine that data did change could be used to quickly verify that a change was made to the code that did, in fact, update the join processing of the query being tested.

The use of SAX callbacks and naming conventions are merely illustrative. Persons skilled in the art will recognize other techniques for identifying structurally significant or insignificant items in a document. In any case, regardless of the particular technique, the control variables 130 (FIG. 1) represent the necessary attributes to implement any such techniques. This is so even though the control variables 130 are shown as part of the UI test tool 112 and, in particular implementations, the control variables 130 physically reside elsewhere (e.g., within the objects 115 of the database 114). Thus, as shown in FIG. 1, the control variables 130 are merely logically representative, and do not necessarily imply a physical structure. Further, the control variables 130 are shown in association with the UI test tool 112 to indicate their configurability from an appropriate interface(s) of the UI test tool 112. For example, the control variables 130 represent selected modes of operation of the UI test tool 112, such as an internationalization mode described in more detail below.

In another specific embodiment, the test expressions are XPATH queries/expressions. Accordingly, the one or more parsers 122 include may include a DOM parser appropriate for parsing documents in a manner allowing the XPATH expressions to be executed. In one embodiment, a comparator 124 is provided to compare a live document to a control document in the manner specified by one or more XPATH expressions and on the basis of any defined control variables 130. As an example, an XPATH expression specifying that everything but the values of a table should be compared may take the following form:
/HTML/body/table/tr/td/ancestor::*. This expression instructs the parser 122 to provide everything above (i.e., an ancestor of) the td elements, thereby having the effect of making everything but the td elements get compared by the comparator 124. In addition to being used to specify which aspects of a live document and corresponding control document to compare, XPATH expressions may also specify specific values for the live document. For example, with reference to the “OUTPUT DOCUMENT FOR A FIRST VERSION OF A DATABASE” shown above, the following expressions could be specified:
   /HTML/body/table/tr/td[1]=beer
   /HTML/body/table/tr/td[2]=eggs
   /HTML/body/table/tr/td[3]=cheese
   The left side of the expression specifies the path to the appropriate element group, while the bracketed number (1, 2 or 3) specifies the specific td. The right side specifies the value for the specific td (beer, eggs, cheese). Accordingly, using XPATH expressions specific values can be targeted.

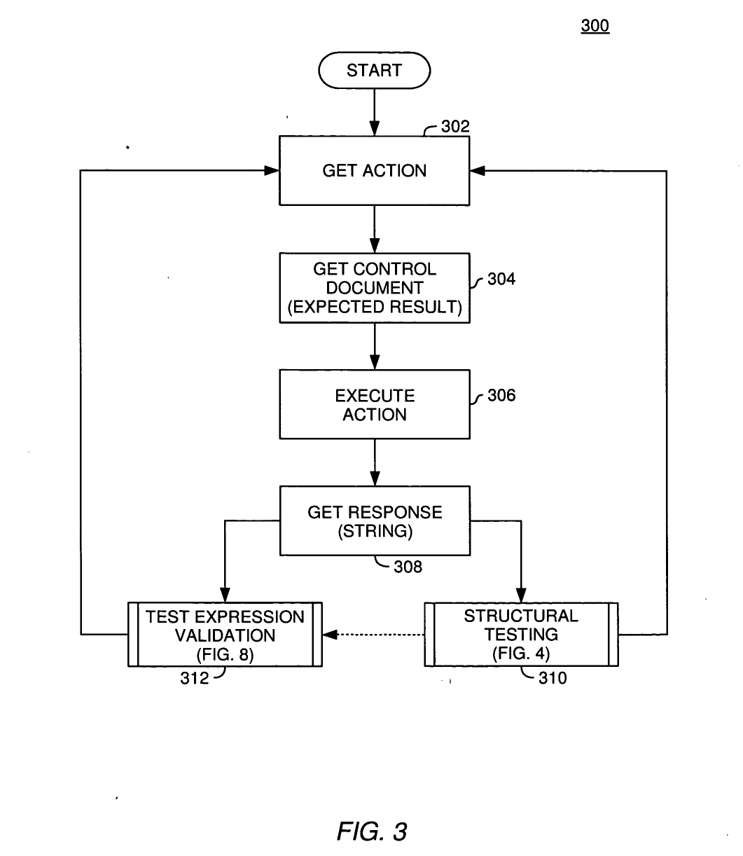

Referring now to FIG. 3, a flowchart as shown illustrating one embodiment of a testing and validation operation 300. The testing and validation operation 300 may be implemented by the UI testing tool 112 and the application 108. The operation 300 is entered when an action (e.g., a user action) specified in one of the stored scripts 129) is retrieved (step 302). Based on the action, the appropriate control document is retrieved (step 304) from the collective control documents 128. The action is then executed (step 306) by an application (e.g., the application 108 of FIG. 1) and a response is received (step 308). The response returned by the application is referred to herein as a live document. Depending on a selected testing mode of the UI testing tool 112, the tool 112 may perform element-by-element testing (step 310) and/or test expression validation (step 312). Thus, it is contemplated that either or both of the testing techniques may be employed. Persons skilled in the art will recognize that other testing techniques may also be employed in combination with either or both of the element-by-element testing technique and the test expression validation technique. After performing the appropriate testing and validation, the operation 300 returns to get the next action (step 302). Accordingly, operation 300 is performed iteratively for each received action until testing and validation is terminated (e.g., the UI testing tool 112 is exited).

FIG. 3 describes, in one aspect, comparing a control document to a live document. However, as will be described in more detail below, some embodiments (specifically, some embodiments of the test expression validation) do not involve a comparison of documents. Further, where a comparison is performed, more than two documents may be compared. That is, for a given control document and request, two or more live documents may be returned and compared to the live document.

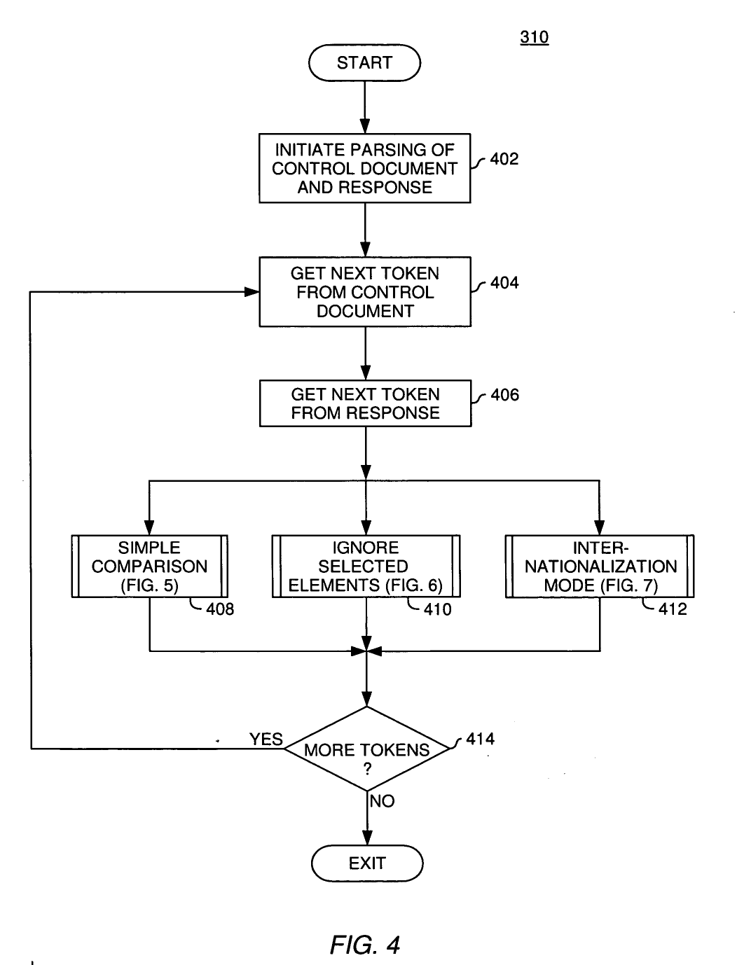

Referring now to FIG. 4, one embodiment of an element-by-element testing operation 310 is shown. In general, “element-by-element testing” refers to comparative testing between sequentially determined elements of at least two documents (i.e., a control document and a live document). By traversing and comparing documents in this manner a degree of structural equivalence between the documents can be determined. For example, the absence or presence of a given structure, such as a table, a button, or a border in each of the documents can be determined. Accordingly, structural equivalence refers to a correspondence in the layout of documents. In addition to determining a degree of structural equivalence between documents, content equivalence can be determined. That is, the absence or presence of specific content (e.g., table data) in the respective documents can also be determined. As noted above, element-by-element testing may be implemented using a SAX parser 122 and an appropriate comparator 124 (both shown in FIG. 1). The structural testing operation begins (at step 402) by initiating parsing of the appropriate control document and response (i.e., the live document). Parsing the documents from beginning to end, the next sequential token is retrieved for each document (steps 404 and 406). In this context, a “token” is any document element of appropriate granularity to perform element-by-element testing. For example, where the documents are XHTML documents a token may be synonymous with a node (i.e., a tag) of the documents. For example, in the “OUTPUT DOCUMENT FOR A FIRST VERSION OF A DATABASE” shown above, the first node is “<html>”. For the two tokens from the respective documents one or more testing and validation techniques/modes (involving comparison of the tokens by the comparator 124) may be applied. In the embodiment illustrated by FIG. 4, three different techniques are contemplated. Which of the three techniques is applied may be dependent upon the specific configuration settings of the UI testing tool 112. After the selected technique(s) is performed, the operation 310 determines whether the control document or the live document contains anymore tokens (step 414). If not, the operation ends; otherwise, processing continues with the next tokens from the control document and the live document (steps 404 and 406).

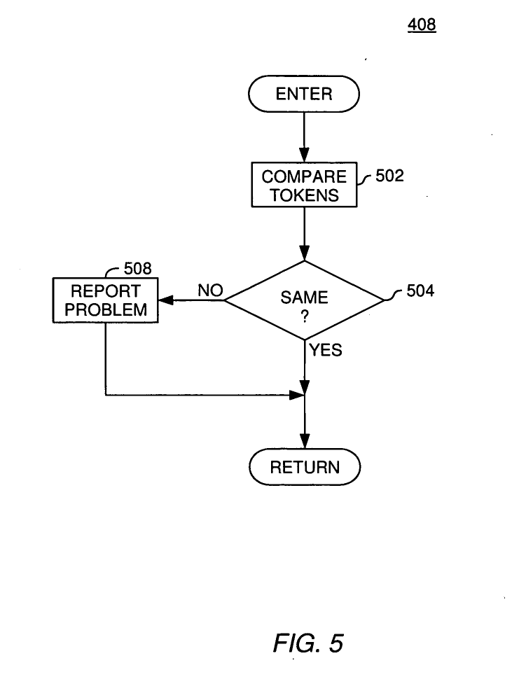

Referring now to FIG. 5, one embodiment of a first testing and validation technique (step 408 of FIG. 4) is shown in which a simple comparison of the tokens is performed by the comparator 124. The technique includes a comparison (step 502) of the tokens to determine (step 504) whether or not the tokens are identical, or sufficiently identical within a predetermined tolerance. If the tokens are sufficiently identical, processing returns to step 414 in FIG. 4. If the tokens are not sufficiently identical, a problem is reported (e.g., the problem is logged or a user is presented with a dialog box indicating the problem). Processing returns to step 414 in FIG. 4.

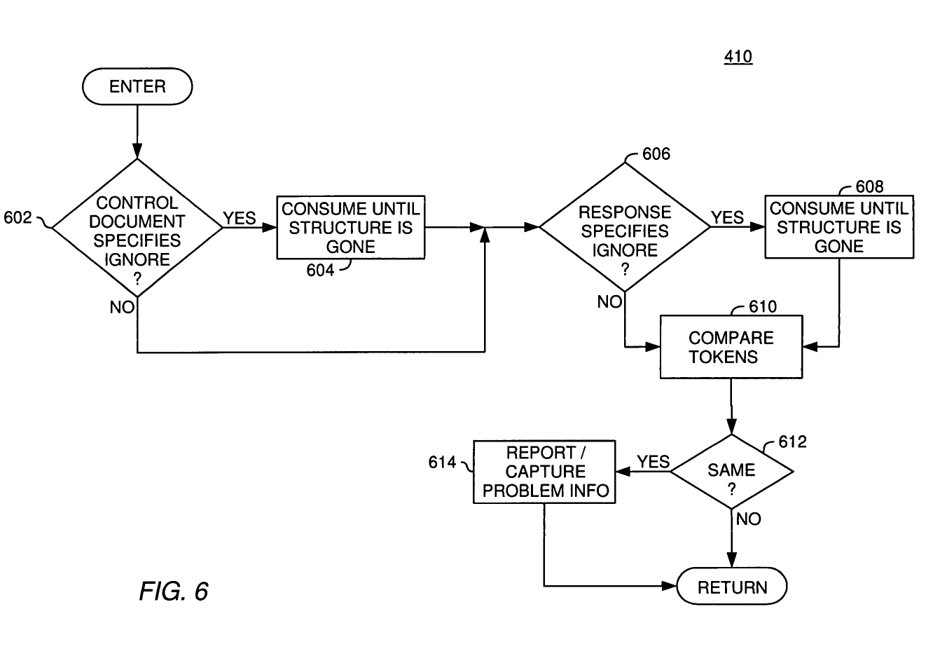

Referring now to FIG. 6, one embodiment of a second testing and validation technique (step 410 of FIG. 4) is shown in which selected data of either or both the documents being compared is ignored. Initially, the token of the control document is examined to determine (step 602) whether the token specifies that a portion of data should be ignored. As was described above, one embodiment for specifying data to be ignored is implemented using a naming convention ID. In this case, if the token is a naming attribute with a double underscore, the token is recognized as specifying a portion of data to be ignored. Accordingly, the specified portion of data (i.e., a defined structure of the document) is consumed (step 604) by the parser. For example, in a control document having a Results Table, a naming attribute id=“_ResultsTable” instructs the parser to ignore (consume without performing a comparison) the structure defined by the <tr> and </tr> tags of the ResultsTable. The same processing is then performed (at steps 606 and 608) for the live document on the basis of the current live document token being processed. In this manner, the parser traverses both the control document and the live document until arriving at a token that the parser is not instructed to ignore. A comparison of these tokens is then performed (step 610) by the comparator 124 to determine whether the tokens are the same, or sufficiently the same (step 612). If the tokens are sufficiently the same, processing returns to step 414 of FIG. 4. If the tokens are not sufficiently the same, a problem is reported (step 614), after which processing returns to step 414 of FIG. 4.

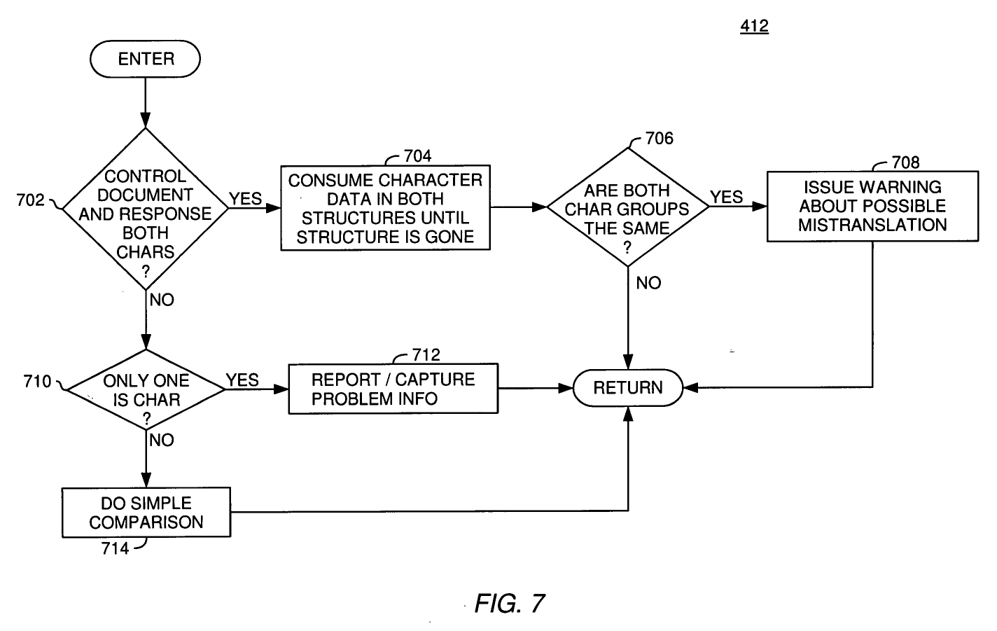

Referring now to FIG. 7 a third technique (step 412) is shown in which the UI testing tool 112 operates in an internationalization mode for the comparison of documents that should be structural the equivalent, but are in different languages. In the illustrative embodiment, internationalization is accomplished by first determining whether the tokens of the control document and live document are character data. If so, the character data in both structures is consumed (step 704) by the parser. The comparator 124 then determines (step 706) whether the consumed character data is the same (or sufficiently similar to a predefined tolerance) in both documents. If not, the documents are assumed to be appropriately translated in their respective languages, and processing returns to step 414 FIG. 4. On the other hand, if the character data is the same a warning is issued (708) about it possible mistranslation. Processing then returns to step 414 FIG. 4.

Returning to step 702, if the control document and the live document do not both contain character data, it is determined whether only one contains character data. If so, a problem is reported (712) since the “type” (i.e., character data type) of tokens being compared should be the same, although the languages are different. Processing then returns to step 414 FIG. 4. If neither token contains character data, a simple comparison of the tokens is performed as was described above with respect FIG. 5.

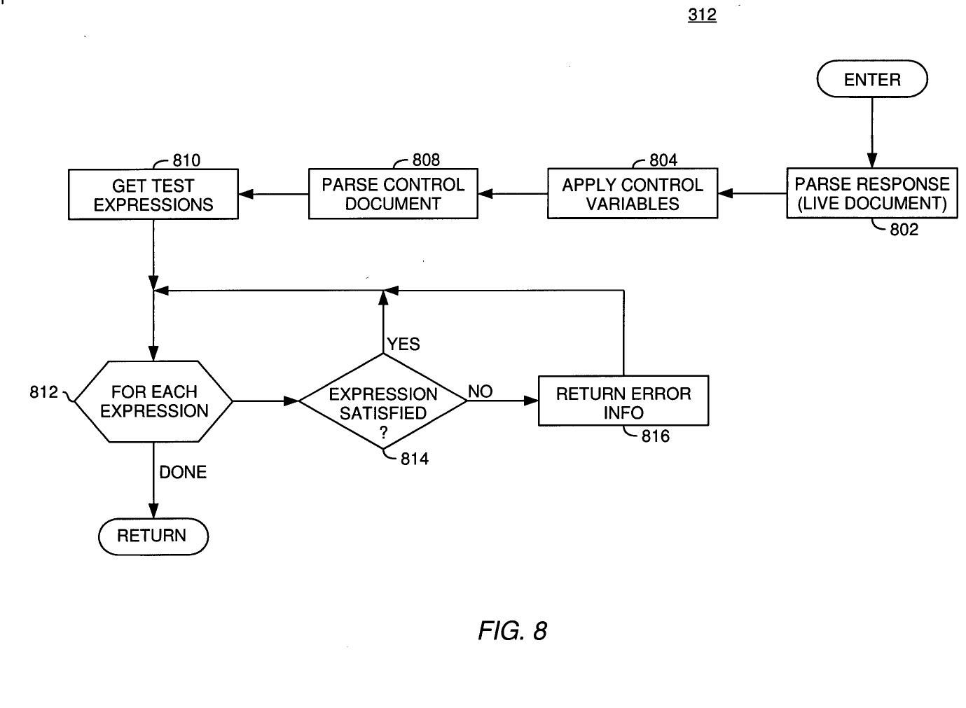

Referring now to FIG. 8, one embodiment of a test expression validation method (step 312 of FIG. 3) is shown. Upon initiating the method 312, the response (i.e., live document) received at step 308 of FIG. 3 is parsed (step 802). Any appropriate, previously defined control variables 130 are then applied. The parser 122 then parses the control document (step 808). Then, the appropriate, previously defined test expressions are retrieved (step 810). The test expressions retrieved are those corresponding to the parsed control document. For each test expression (step 812), the expression is applied (step 814) and then a determination is made as to whether the expression is satisfied (step 816). As noted above, determining whether a particular test expression is satisfied may vary according to different embodiments. In one embodiment, a given test expression may be applied to both documents, after which the documents are compared based on the control variables to the documents. This approach may be useful, for example, where a test expression specifies which portions of the documents to compare. Where, however, the test expression specifies specific values for the live document, a comparison of the documents is not required.

The foregoing embodiments have been described with respect to testing and validation of user interfaces. However, persons skilled in the art will recognize that the techniques described above also apply in other contexts, such as Web Service testing. For example, the results of a Web Service configured to execute a query can be validated as being structurally correct via some constraints (e.g., column names, data types, number of columns, etc.) but variable in number of rows returned. Consider further a Web service that is designed to return whatever string is passed into it; call it “Parrot”. In order to test the Parrot Web service there are a number of items that should be verified. One item is that, given a value, Parrot returns that value. Also requiring verification would be how to handle various situations like only one character input, no characters input, a very large character input, special characters in foreign languages, etc. The Parrot Web service would be tested for each of these scenarios and in each case a well-formed XML result would be returned. The series of test inputs would be stored as the test script. The return values would be validated for initial correctness and stored as the control documents. New return values from the Parrot Web service (for the test script) can then be compared to the saved control documents. Naming conventions or other constructs can be defined as a means allowing variations over releases of the Web service. XPATH queries can be used for targeted comparisons and control variables can be set to allow for validation mode selection (such as enabling internationalization mode comparisons) and making other configurable selections.

While the foregoing is directed to embodiments of the present invention, other and further embodiments of the invention may be devised without departing from the basic scope thereof, and the scope thereof is determined by the claims that follow.

1. A method of testing content, comprising:
parsing, by a parser, two or more documents in tandem on an element-by-element basis, whereby the elements of each of the documents are sequentially parsed;
upon parsing each of the respective sequential elements in a first document of the two or more documents and each of the other documents, comparing the respective parsed elements to one another; and
on the basis of the comparison, determining whether the documents are at least equivalent.

2. The method of claim 1, wherein each of the other documents is a current response from an application responding to a submitted request and the first document is a control document retrieved from storage and previously returned from the application in response to the request.

3. The method of claim 1, wherein the parser is a SAX parser.

4. The method of claim 1, further comprising, upon determining that the documents are not equivalent, issuing a user warning.

5. The method of claim 1, further comprising, disregarding, for purposes of the comparing, elements of at least one of the documents identified by predefined attributes identifiable by the parser.

6. The method of claim 1, wherein determining whether the documents are at least equivalent comprises determining whether the documents are structurally equivalent and wherein comparing the parsed documents comprises:
comparing sequentially occurring non-character elements in the respective documents; and
disregarding character elements; and
wherein determining whether the documents are equivalent comprises determining whether the non-character elements are the same.

7. The method of claim 1, wherein determining whether the documents are at least equivalent comprises determining whether the documents are at least one of structurally equivalent and content equivalent.

8. The method of claim 7, wherein the documents are foreign-language counterparts of one another; and wherein comparing the parsed documents comprises comparing sequentially occurring elements in the respective documents; and wherein determining whether the documents are structurally equivalent comprises determining whether the non-character elements are the same; and further comprising determining whether the documents are content equivalent by determining whether the character elements are different.

9. The method of claim 8, upon determining that the documents are content equivalent, issuing a warning of a possible mistranslation-of content in at least one of the documents.

10. The method of claim 1, wherein the documents are XML documents containing XHTML.

11. The method of claim 1, wherein the documents are well-formed documents having well-defined content structures identifiable by a parser parsing the documents.

12. The method of claim 1, further comprising:
applying one or more test expressions to at least one of the documents; and
determining whether the one or more test expressions are satisfied.

13. The method of claim 12, wherein the one or more test expressions are XPATH queries.

14. A method of testing and validating user interface content, comprising:
submitting a request to an application;
in response to the request, receiving a response document from the application;
retrieving from storage a control document previously returned from the application in response to the request;
sequentially determining each element of the response document and the control document;
for at least some of the respective sequentially determined elements from the respective documents, comparing the elements to one another; and
on the basis of the comparison, determining whether the elements are equivalent.

15. The method of claim 14, wherein the documents contain XHTML and the elements are nodes of XHTML content of the respective documents.

16. The method of claim 14, wherein at least two response documents are returned in response to the request and wherein the steps of sequentially determining each element, comparing the elements and determining whether the elements are equivalent is performed are performed for all of the documents.

17. The method of claim 14, wherein comparing the elements to each other comprises:
comparing sequentially occurring non-character elements in the respective documents; and
disregarding character elements.

18. The method of claim 14, further comprising, for at least some of the respective sequentially determined elements from respective documents, disregarding the elements.

19. The method of claim 14, wherein sequentially determining the elements of the documents comprises parsing the respective documents and wherein the documents are well-formed documents having well-defined elements identifiable by a parser parsing the documents.

20. The method of claim 19, wherein the parser is a SAX parser.

21. The method of claim 14, wherein the documents are foreign-language counterparts of one another and further comprising:
upon determining that the documents are equivalent, issuing a warning of a possible mistranslation in at least one of the documents.

22. The method of claim 14, wherein a first document is a control document previously returned from an application in response to a user action, and then captured, stored and subsequently retrieved from storage to determine a first structural element for comparison.

23. The method of claim 22, wherein a second document is a live document currently returned from the application in response to the user action during a session in which the application is being accessed.

24. The method of claim 14, wherein the documents are XML documents containing XHTML.

25. The method of claim 14, further comprising:
applying a test expression to the documents, the test expression being configured to select specific portions of the documents; and
comparing the specific portions for equivalence.

26. The method of claim 25, wherein sequentially determining the elements comprises parsing the respective documents.

27. The method of claim 14, further comprising:
applying one or more test expressions to at least one of the documents; and
determining whether the one or more test expressions are satisfied.

28. The method of claim 27, wherein the one or more test expressions are XPATH queries.

29. The method of claim 27, wherein at least one test expression is configured to determine a presence of a specific value of a structural element of the second document.

30. The method of claim 27, wherein sequentially determining the elements comprises parsing the respective documents:

31. A method for testing and validating content in a user interface, comprising:
a) performing a first testing and validation technique, comprising:
parsing a first document with a first parser;
parsing a second document with the first parser;
comparing the parsed first document to the parsed second document;
on the basis of the comparison, determining whether the documents are equivalent; and
b) performing a second testing and validation technique, comprising:
parsing the second document with a second parser;
applying one or more test expressions to the parsed second document; and
determining whether the one or more test expressions are satisfied.

32. The method of claim 31, wherein determining whether the documents are equivalent comprises determining whether the documents are structurally equivalent.

33. The method of claim 31, wherein determining whether the documents are equivalent comprises determining whether selected portions of the documents are equivalent in content.

34. The method of claim 31, wherein the first parser is at SAX parser.

35. The method of claim 31, wherein the first parser is at SAX parser and the second parser is a DOM parser.

36. The method of claim 31, wherein the first parser is at SAX parser, the second parser is a DOM parser and the one or more test expressions are XPATH queries.

37. A computer readable medium containing a program which, when executed, performs an operation for testing content, comprising:
parsing a first document being well-formed and having identifiable structures;
parsing a second document being well-formed and having identifiable structures;
comparing the parsed first document to the parsed second document; and
on the basis of the comparison, determining whether the documents are at least structurally equivalent.

38. The computer readable medium of claim 37, wherein the parsing is done by a SAX parser.

39. The computer readable medium of claim 37, further comprising, upon determining that the documents are not structurally equivalent, issuing a user warning.

40. The computer readable medium of claim 37, further comprising determining whether the documents are content equivalent.

41. The computer readable medium of claim 37, wherein comparing the parsed documents comprises:
comparing sequentially occurring non-character elements in the respective documents; and
disregarding character elements; and
wherein determining whether the documents are structurally equivalent comprises determining whether the non-character elements are the same.

42. The computer readable medium of claim 37, wherein the documents are foreign-language counterparts of one another and wherein comparing the parsed documents comprises:
comparing sequentially occurring elements in the respective documents; and
wherein determining whether the documents are structurally equivalent comprises determining whether the non-character elements are the same; and further comprising determining whether the documents are content equivalent by determining whether the character elements are different.

43. The computer readable medium of claim 42, upon determining that the documents are content equivalent, issuing a warning of a possible mistranslation of content in at least one of the documents.

44. The computer readable medium of claim 37, wherein the documents are XML documents containing XHTML.

45. The computer readable medium of claim 37, further comprising:
applying one or more test expressions to at least one of the documents; and
determining whether the one or more test expressions are satisfied.

46. The computer readable medium of claim 45, wherein the one or more test expressions are XPATH queries.

47. A computer, comprising:
a user interface testing tool comprising at least a first parser and a comparator, and operable to perform at least a first testing technique in which the tool is configured to:
retrieve a first document from storage, the first document having been previously returned from an application in response to user input;
request and receive a second document from the application during a current session in which the application is being accessed by the user interface testing tool;
parse the first document using the first parser;
parse the second document using the first parser;
compare, by the comparator, the parsed first document to the parsed second document; and
on the basis of the comparison, determine at least whether the documents are at least structurally equivalent.

48. The computer of claim 47, wherein the documents are well-formed and have identifiable structures.

49. The computer of claim 47, wherein the parsing is done by a SAX parser.

50. The computer of claim 47, wherein the user interface testing tool is further configured to issue a user warning upon determining that the documents are not structurally equivalent.

51. The computer of claim 47, wherein the user interface testing tool is further configured to determine whether the documents are content equivalent.

52. The computer of claim 47, wherein the user interface testing tool compares the parsed documents by:
comparing sequentially occurring non-character elements in the respective documents; and
disregarding character elements; and
wherein the user interface testing tool determines whether the documents are structurally equivalent by determining whether the non-character elements are the same.

53. The computer of claim 47, wherein the documents are foreign-language counterparts of one another and wherein the user interface testing tool compares the parsed documents by:
comparing sequentially occurring elements in the respective documents; and
wherein the user interface testing tool determines whether the documents are structurally equivalent by determining whether the non-character elements are the same; and further determines whether the documents are content equivalent by determining whether the character elements are different.

54. The computer of claim 53, wherein the user interface testing tool is further configured to issue a warning of a possible mistranslation of content in at least one of the documents upon determining that the documents are content equivalent.

55. The computer of claim 47, wherein the documents are XML documents containing XHTML.

56. The computer of claim 47, wherein the documents are well-formed documents having well-defined content structures identifiable by the first parser.

57. The computer of claim 47, further comprising:
applying one or more test expressions to at least one of the documents; and
determining whether the one or more test expressions are satisfied.

58. The computer of claim 57, wherein the one or more test expressions are XPATH queries.

59. The computer of claim 47, further comprising:
parsing the first and second documents with a second parser;
applying one or more test expressions to at least one of the documents parsed by the second parser; and
determining whether the one or more test expressions are satisfied.
